(19) United States
(12) Patent Application Publication
(10) Pub. No.: US 2010/0225857 A1
(43) Pub. Date: Sep. 9, 2010

(54) BACKLIGHT RECIRCULATION IN TRANSFLECTIVE LIQUID CRYSTAL DISPLAYS

(75) Inventors: Ruibo Lu, San Bruno, CA (US); Mary Lou Jepsen, Sausalito, CA (US)

Correspondence Address: HICKMAN PALERMO TRUONG & BECKER, LLP, 2055 GATEWAY PLACE, SUITE 550, SAN JOSE, CA, 95110, US

(73) Assignee: PIXEL QI CORPORATION, San Bruno, CA (US)

(21) Appl. No.: 12/560,258

(22) Filed: Sep. 15, 2009

Related U.S. Application Data
(60) Provisional application No. 61/158,399, filed on Mar. 9, 2009.

(51) Int. Cl. G02F 1/1335; G02F 1/13

(52) U.S. Cl. 349/98; 349/114; 349/187

(57) ABSTRACT

Techniques are provided to recycle light from a backlight unit that is otherwise blocked in a reflective part of a pixel in a transflective LCD. The light is redirected into a transmissive part of the pixel and hence enhances light efficiency and luminance of the pixel. The techniques can be used in a transflective LCD that transmits light in a circularly polarized state, or a linearly polarized state.

### BENEFIT CLAIM

This application claims the benefit, under 35 U.S.C. 119(e), of prior provisional application 61/158,399, filed Mar. 9, 2009, the entire contents of which are hereby incorporated by reference for all purposes as if fully set forth herein.

### CROSS REFERENCE TO RELATED APPLICATIONS

This application is related to U.S. patent application Ser. No. 12/503,793, filed Jul. 15, 2009, the entire contents of which are hereby incorporated by reference for all purposes as if fully disclosed herein.

### TECHNICAL FIELD

The present disclosure relates to Liquid Crystal Displays (LCDs).

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Transflective LCDs may be used in cell phones, electronic books, and personal computers in part because readability of transflective LCDs typically is not limited by ambient lighting conditions. A transflective LCD comprises an array of pixels each having a reflective part and a transmissive part. In the reflective part of a transflective LCD pixel, there may be a metal reflector over a thin film transistor unit. In transflective LCDs that use a relatively small metal reflector in a pixel, while enough backlight may be able to transmit through the pixel, not enough ambient light is reflected to show the pixel at a desired luminance.

On the other hand, in transflective LCDs that use a relatively large metal reflector in a pixel, while enough ambient light may be reflected, not enough backlight is able to transmit through the pixel. For instance, a circularly polarized backlight may be blocked by the relatively large metal reflector in the reflective part and cannot be efficiently redirected into the transmissive part. This significantly lowers the optical output efficiency of the backlight units (BLUs), and reduces overall light transmittance and brightness in pixels of the transflective LCDs. The problem becomes especially severe when the area of the reflective part is comparable to or larger than that of the transmissive part in the pixel.

### BRIEF DESCRIPTION OF THE DRAWINGS

Various embodiments of the present invention will herein after be described in conjunction with the appended drawings, provided to illustrate and not to limit the present invention, wherein like designations denote like elements, and in which:

FIG. 1 illustrates a schematic cross-sectional view of an example transflective LCD unit structure configured to transmit linearly polarizer light with a polarization recycling film.

FIG. 2 illustrates a schematic cross-sectional view of an example transflective LCD unit structure configured to transmit linearly polarizer light with a polarization recycling film and a light redirecting film.

FIG. 3 illustrates a schematic cross-sectional view of an example transflective LCD unit structure configured to transmit circularly polarizer light with a reflective polarizer.

FIG. 4 illustrates a schematic cross-sectional view of an example transflective LCD unit structure configured to transmit circularly polarizer light with a reflective polarizer and a light redirecting film.

The drawings are not rendered to scale.

### DETAILED DESCRIPTION

Techniques for recycling backlight in a transflective LCD are described. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

1. General Overview

In an embodiment, to effectively recycle backlight, a first metallic reflective layer is adjacent to an inner surface of a bottom substrate in the reflective part of a transflective LCD unit structure. As used herein, “an inner surface of a bottom substrate” refers to a surface of the bottom substrate facing a liquid crystal material in the transflective LCD unit structure, as further described. The term “transflective LCD unit structure” may refer to a pixel or a sub-pixel in the transflective LCD.

A reflective region may be located between the first metallic reflective layer and the backlight. The reflective region may comprise an over-coating layer of a scattering or diffusive type. Additionally and/or optionally, a first phase tuning film may be formed between the first metallic reflective layer and a BLU in the reflective part to alter the phase or polarity state of the recycled light passing through the first phase tuning film.

In some embodiments, the first metallic reflective layer is next to the inner surface of the bottom substrate. In some embodiments, the first metallic reflective layer is present in addition to a second metallic reflective layer, which is located on the top side of the over-coating layer, close to the liquid crystal layer. The second metallic reflective layer may be a bumpy metal reflector with a bumpy surface structure facing ambient light. Thus, in these configurations, a pixel comprises at least two metal reflective components in the reflective part. While the second metallic reflective layer effectively reflects ambient light, the first metallic reflective layer adjacent to the inner surface of the bottom substrate effectively re-circulates the backlight received from the BLU. In some embodiments, one or both metallic reflective layers comprise an opaque metal layer such as aluminum (Al) or silver (Ag).

In some embodiments, a portion of backlight may be also reflected and re-circulated by the BLU-facing surface of the second metallic reflective layer. In these embodiments, a second phase tuning film also may be inserted between the second metallic reflective layer and the BLU in the reflective part to alter the phase or polarity of the recycled light passing through the second phase tuning film.

In some embodiments, a transflective LCD as described herein transmits linearly polarized light. In these embodiments, the transflective LCD may be configured with one or more linear polarizers.

In some embodiments, a transflective LCD as described herein transmits circularly polarized light. In these embodiments, the transflective LCD may be configured with one or more circular polarizers, comprising a quarter-wave plate or a combination of a half-wave plate and a quarter-wave plate. Linearly polarized light may be reflected by the metal reflective layers and recycled one or more times within the reflective region until exiting through the transmissive part towards a viewer.

Circularly polarized light may be reflected by the metal reflective layers and depolarized into one or other mixed light polarization states to be reflected into the transmissive part. Typically the reflected light is elliptically polarized. To better redirect the scattered elliptically polarized light into the transmissive part, the pixel structure may comprise a light redirecting prism film. To better recycle the scattered unpolarized or elliptically polarized light into the transmissive part, the pixel structure may comprise a cholesteric liquid crystal film as a circularly polarized light reflector.

In embodiments, light from the BLU is effectively re-circulated from the reflective part to the transmissive part to increase the optical output of the BLU and to further enhance the brightness of the transmissive part.

Benefits of this approach include a transflective LCD with high backlight output efficiency. Additional benefits include a transflective LCD characterized by higher brightness and significantly lower power consumption than otherwise. These characteristics are valuable for various applications in different operating modes. For example, the transflective LCD described herein can show color images in the transmissive mode and the transflective mode, and black-and-white monochromatic images in the reflective mode with good ambient light readability and low power consumption.

In some embodiments, a transflective LCD as described herein forms a part of a computer, including but not limited to a laptop computer, netbook computer, cellular radiotelephone, electronic book reader, point of sale terminal, desktop computer, computer workstation, computer kiosk, or computer coupled to or integrated into a gasoline pump, and various other kinds of terminals and display units.

In some embodiments, a method comprises providing a transflective LCD as described, and a backlight source to the transflective LCD.

Various modifications to the preferred embodiments and the generic principles and features described herein will be readily apparent to those skilled in the art. Thus, the disclosure is not intended to be limited to the embodiments shown, but is to be accorded the widest scope consistent with the principles and features described herein.

2. structural overview

2.1 Linear Polarization

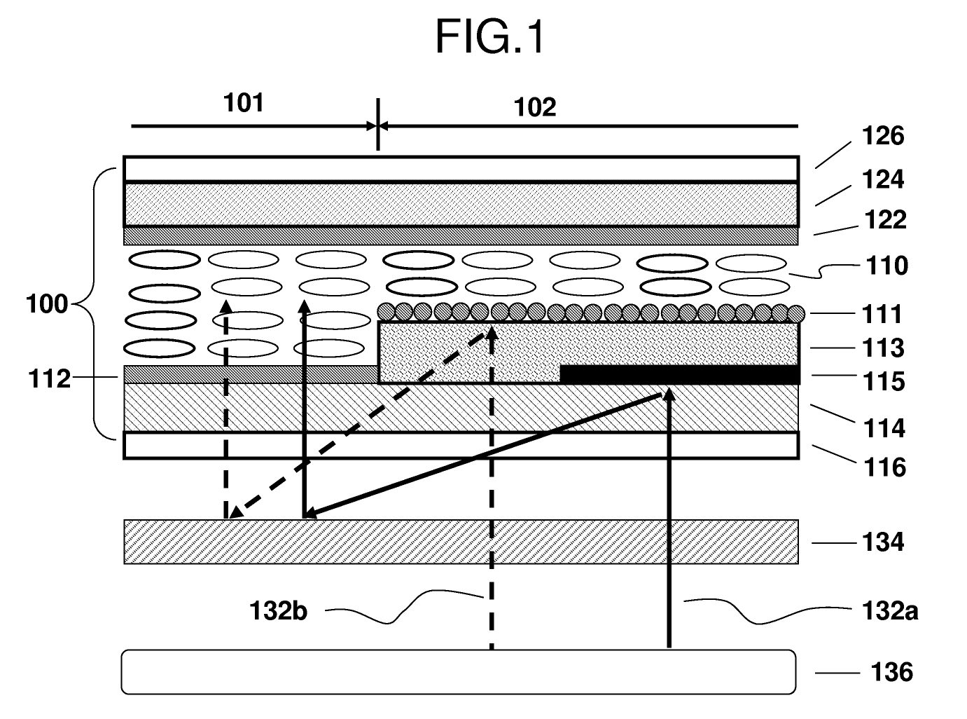

FIG. 1 illustrates a schematic cross-sectional view of an example transflective LCD unit structure 100. The LCD unit structure 100, which may comprise a pair of linear polarizers to transmit linearly polarized light, comprises a configuration for recycling linearly polarized light.

In some embodiments, the LCD unit structure 100 comprises at least a transmissive part 101 and a reflective part 102. A liquid crystal layer 110 is located between a bottom substrate 114 and a top substrate 124. The transmissive part 101 may have a different liquid crystal cell gap than that of the reflective part 102. As used in this disclosure, “a liquid crystal cell gap” refers to the thickness of the liquid crystal layer in either the transmissive part or the reflective part.

An over-coating layer 113 may be deposited in the reflective part 102 to make the liquid crystal cell gap of the reflective part smaller than the liquid crystal cell gap of the transmissive part 101. In some embodiments, in part due to the over-coating layer 113, the liquid crystal cell gap in the reflective part 102 may be approximately half of the liquid crystal cell gap in the transmissive part 101. In various embodiments, the over-coating layer 113 may comprise acrylic resin, polyamide, or novolac epoxy resin. The over-coating layer 113 may be doped with inorganic particles such as silicon oxide (SiO2) to provide scattering and diffusive optical properties.

A first metallic reflective layer 115 may be on the inner surface of the bottom substrate 114 in the reflective part 102, which is the top surface of the bottom substrate 114 in FIG. 1. The first metallic reflective layer 115 can be prepared during a TFT process either as an extended gate metal or a separate reflective metal layer. The first metallic reflective layer 115 may comprise an opaque reflective metal material such as Al or Ag, and may occupy all or a portion of the total area of the reflective area 102. The inner surface, which is the top surface in FIG. 1, of over-coating layer 113 may be covered with a second metallic reflective layer 111 such as aluminum (Al) or silver (Ag) to work as the reflective electrode. In some embodiments, this second metallic reflective layer 111 may be a bumpy metal layer.

The bottom substrate 114 may be made of glass. On the inner surface of the bottom substrate 114 in the transmissive part 101, a transparent indium-tin oxide (ITO) layer 112 may be provided as the pixel electrode. Color filters, not shown in FIG. 1, may be deposited on or near a surface of the top substrate 124. The color filters may cover both the transmissive part 101 and the reflective part 102, or only cover the transmissive part 101. An ITO layer 122 may be located between the top substrate 124 and the liquid crystal layer 110 as a common electrode. A bottom linear polarizer 116 and a top linear polarizer 126 may be attached on outer surfaces of the bottom substrate 114 and top substrate 124 respectively.

A polarization recycling film 134 may be located between the BLU 136 and the bottom linear polarizer 116. The polarization recycling film 134 may comprise a dual brightness enhancement film that reflects the light of one polarization state such as a first transverse polarization state and transmits the light of the other polarization state such as a second transverse polarization state orthogonal to the first transverse polarization state. The polarization recycling film 134 may comprise multiple layers. In one embodiment, the dual brightness enhancement film may be a Vikuiti™ DBEF film, commercially available from 3M.

In operation, in the reflective part 102, incident backlight 132a from BLU 136 first passes through the light recycling film 134, and then enters the bottom linear polarizer 116 with a particular linear polarization state into the bottom region of the reflective part 102. The incident backlight 132a incidents on the first metallic reflective layer 115. Similarly, incident backlight 132b may incident on the bottom surface of the second metallic reflective layer 111. The incident backlight 132a and 132b may be randomly reflected and passes through the bottom linear polarizer 116 with the same polarization state. Reflected by polarization recycling film 134, the incident light 132a and 132b may be recycled and redirected into the transmissive part 101 from the region either (1) covered by the first metallic reflective layer 115 or (2) uncovered by the first metallic reflective layer 115 but covered by the second metallic reflective layer 111.

In this way, the BLU light portion in the reflective part 102 is recycled into the transmissive part 101 and the backlight recirculation is realized. Through the backlight recirculation as described herein, more light is redirected into the transmissive part 101 from the reflective part 102. Therefore, high optical output efficiency from BLU is obtained and enhanced brightness in the transmissive part 101 can be achieved. Since more backlight is more efficiently used, the power consumption from BLU can be reduced, resulting in a transflective LCD having efficient power saving ability.

2.2 Linear Polarization with a Light Redirecting Film

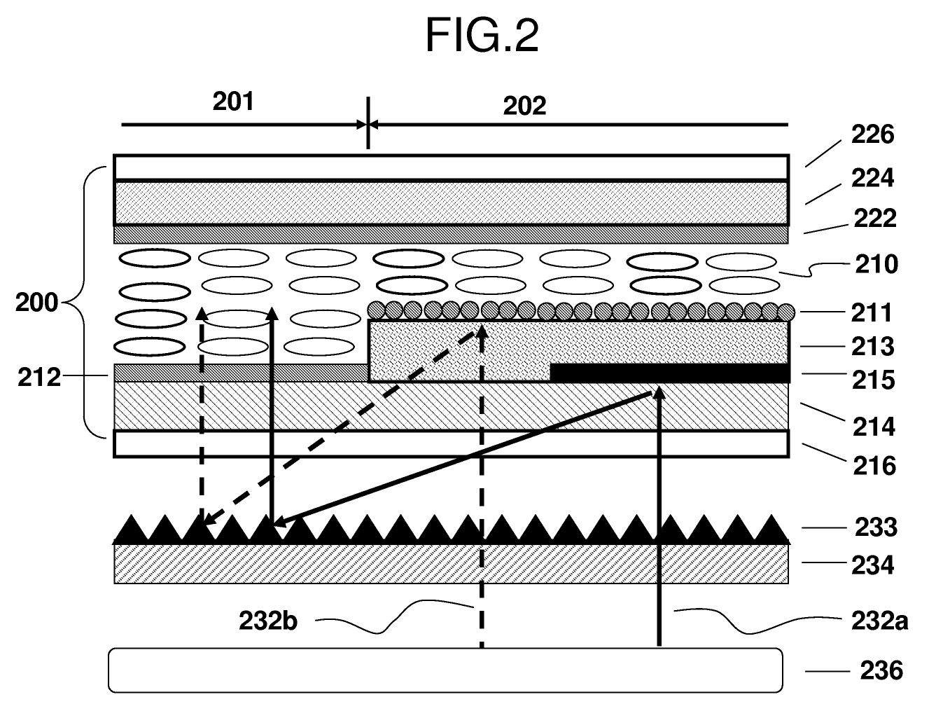

FIG. 2 illustrates a schematic cross-sectional view of an example transflective LCD unit structure 200. The LCD unit structure 200, which may comprise a pair of linear polarizers to transmit linearly polarized light, comprises a configuration for recycling linearly polarized light.

In some embodiments, the LCD unit structure 200 comprises at least a transmissive part 201 and a reflective part 202. A liquid crystal layer 210 is located between a bottom substrate 214 and a top substrate 224. The transmissive part 201 may have a different liquid crystal cell gap than the liquid crystal cell gap of the reflective part 202.

An over-coating layer 213 may be located in the reflective part 202 to make the liquid crystal cell gap of the reflective part smaller than the liquid crystal cell gap of the transmissive part 201. In some embodiments, in part due to the over-coating layer 213, the liquid crystal cell gap in the reflective part 202 may be approximately half of the liquid crystal cell gap in the transmissive part 201. The material of the over-coating layer 213 may comprise acrylic resin, polyamide, or novolac epoxy resin. The over-coating layer 213 may be doped with inorganic particles such as silicon oxide (SiO2) to provide scattering and diffusive optical properties.

A first metallic reflective layer 215 may be located on the inner surface of the bottom substrate 214 in the reflective part 202, which is the top surface of the bottom substrate 214 in FIG. 2. The first metallic reflective layer 215 can be prepared during a TFT process either as an extended gate metal or a separate reflective metal layer. The first metallic reflective layer 215 may comprise an opaque reflective metal material such as Al or Ag, and occupy all or a portion of the total area of the reflective area 202. The inner surface, which is the top surface in FIG. 2, of over-coating layer 213 may be covered with a second metallic reflective layer 211 such as aluminum (Al) or silver (Ag) to work as the reflective electrode. In some embodiments, this second metallic reflective layer 211 may be a bumpy metal layer.

The bottom substrate 214 may be made of glass. On the inner surface of the bottom substrate 214 in the transmissive part 201, a transparent indium-tin oxide (ITO) layer 212 may be provided as the pixel electrode. Color filters, not shown in FIG. 2, may be deposited on or near a surface of the top substrate 224. The color filters may cover both the transmissive part 201 and the reflective part 202, or only cover the transmissive part 201. An ITO layer 222 may be located between the top substrate 224 and the liquid crystal layer 210 as a common electrode. A bottom linear polarizer 216 and a top linear polarizer 226 may be attached on outer surfaces of the bottom substrate 214 and top substrate 224 respectively.

A light redirecting film 233 and a polarization recycling film 234 may be located between the BLU 236 and the bottom linear polarizer 216. The light redirecting film 233 can be a tilted prismatic film and serves as a light directional tuning film to direct incident light to a desired substantially vertical up direction in FIG. 2 after the incident light enters or reflects from the light redirecting film 233. The light redirecting prismatic film 233 can cover both the transmissive part 201 and the reflective part 202 as a whole, or alternatively comprise a pattern that covers the reflective part 202 only. To illustrate a clear example, the light redirecting film 233 is depicted in FIG. 2 as having a symmetric reflective surface. In some embodiments, the reflective surface of the light redirecting film 233 may be configured with a non-symmetric reflective surface to redirect incident light to the transmissive part 201. For example, the reflective surface on the light redirecting film 233 further away from the transmissive part 201 may be less tilted than that near the transmissive part 201.

The polarization recycling film 234 can function as a dual brightness enhancement film that reflects the light of one polarization state such as a first transverse polarization state and transmits the light of the other polarization state such as a second transverse polarization state orthogonal to the first transverse polarization state. The polarization recycling film 234 may comprise multiple layers internally. In a particular embodiment, the dual brightness enhancement film may be the Vikuiti™ DBEF film.

In operation, in the reflective part 202, incident backlight 232a from BLU 236 first passes through the light recycling film 234 and light redirecting film 233, and then enters the bottom linear polarizer 216 with a particular linear polarization state into the bottom region of the reflective part 202. The incident backlight 232a incidents on the first metallic reflective layer 215. Similarly, incident backlight 232b may incident on the bottom surface of the second metallic reflective layer 211. The incident backlight 232a and 232b may be randomly reflected and passes through the bottom linear polarizer 216 with the same polarization state. Reflected by polarization recycling film 234 and redirected by light redirecting film 233, the incident light 232a and 232b may be recycled and redirected into the transmissive part 201 from the region either (1) covered by the first metallic reflective layer 215 or (2) uncovered by the first metallic reflective layer 215 but covered by the second metallic reflective layer 211.

In this way, the BLU light portion in the reflective part 202 is recycled into the transmissive part 201 and the backlight recirculation is realized. Through backlight recirculation as described herein, more light is redirected into the transmissive part 201 from the reflective part 202. Therefore, high optical output efficiency from BLU can be obtained and enhanced brightness in the transmissive part 201 can be achieved. Since more backlight is more efficiently used, the power consumption from BLU can be reduced, resulting in a transflective LCD having efficient power saving ability.

2.3 Circular Polarization

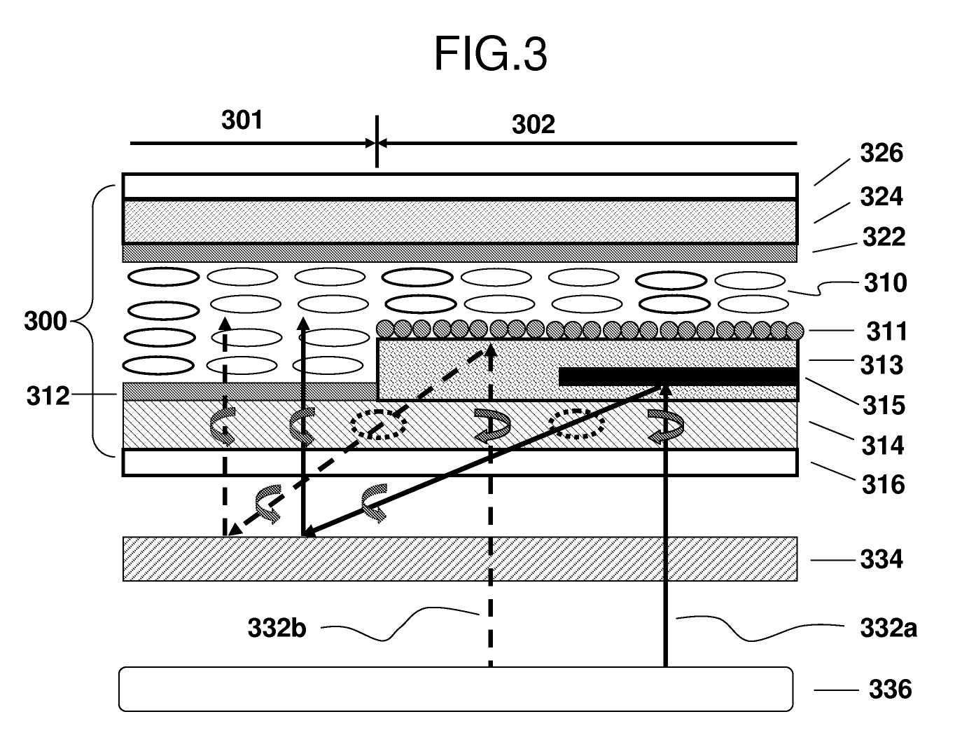

FIG. 3 illustrates a schematic cross-sectional view of an example transflective LCD unit structure 300. This LCD unit structure 300, which may comprise a pair of circular polarizers, to transmit circularly polarized light, comprises a configuration for recycling circularly polarized light. A circular polarizer may comprise a linear polarizer with a quarter-wave plate, or comprise a linear polarizer with a half-wave plate and a quarter-wave plate to form a wide-band circular polarizer.

In some embodiments, the LCD unit structure 300 comprises at least a transmissive part 301 and a reflective part 302. A liquid crystal layer 310 is located between a bottom substrate 314 and a top substrate 324. The transmissive part 301 may have a different liquid crystal cell gap than a liquid crystal cell gap of the reflective part 302.

An over-coating layer 313 may in the reflective part 302 to make the liquid crystal cell gap of the reflective part smaller than the liquid crystal cell gap of the transmissive part 301. In some embodiments, in part due to the over-coating layer 313, the liquid crystal cell gap in the reflective part 302 may be approximately half of that in the transmissive part 301. The material of the over-coating layer 313 may comprise acrylic resin, polyamide, or novolac epoxy resin. The over-coating layer 313 may be doped with inorganic particles such as silicon oxide (SiO2) to provide scattering and diffusive optical properties. In some embodiments, the over-coating layer 313 may comprise an anisotropic liquid crystal material doped with suitable dopants in order to perform a phase tuning function. In some other embodiments, the over-coating layer 313 may be a polymer liquid crystal material.

A first metallic reflective layer 315 may be located on the inner surface of the bottom substrate 314 in the reflective part 302, which is the top surface of the bottom substrate 314 in FIG. 3. The first metallic reflective layer 315 can be prepared during a TFT process either as an extended gate metal or a separate reflective metal layer. The first metallic reflective layer 315 can comprise an opaque reflective metal material such as Al or Ag, and occupy all or a portion of the total area of the reflective area 302. The inner surface, which is the top surface in FIG. 3, of over-coating layer 313 may be covered with a second metallic reflective layer 311 such as aluminum (Al) or silver (Ag) to work as the reflective electrode. In some embodiments, this second metallic reflective layer 311 may be a bumpy metal layer.

The bottom substrate 314 may be made of glass. On the inner surface of the bottom substrate 314 in the transmissive part 301, a transparent indium-tin oxide (ITO) layer 312 may be provided as the pixel electrode. Color filters, not shown in FIG. 3, may be located on or near a surface of the top substrate 324. The color filters may cover both the transmissive part 301 and the reflective part 302, or only cover the transmissive part 301. An ITO layer 322 may be further located between the top substrate 324 and the liquid crystal layer 310 as a common electrode. A bottom circular polarizer 316 and a top circular polarizer 326 may be attached on outer surfaces of the bottom substrate 314 and top substrate 324 respectively.

A reflective polarizer 334 may be further added between the BLU 336 and the bottom circular polarizer 316. The reflective polarizer 334 may comprise a cholesteric liquid crystal film working as a circularly polarized light reflector. The reflective polarizer 334 can reflect the circularly light of one polarizing handedness such as the right-handed one and transmit the circularly light of the other polarizing handedness such as the left-handed one. The reflective polarizer 334 may also comprise multiple layers that enable light recycling. In a particular embodiment, the reflective polarizer 334 may be a CLC film commercially available from Merck.

In operation, in the reflective part 302, incident light 332a and incident light 332b from BLU 336 first passes through the reflective polarizer 334, and then enter the bottom circular polarizer 316 with, for example, a left-handed circularly polarized light state into the bottom region of the reflective part 302. Incident light 332a and incident light 332b, which may be unpolarized at the initial stage from the BLU 336, pass through the bottom circular polarizer 316, and the corresponding light polarization states become the left-handed circularly polarized light polarization states.

The incident light 332a and the incident light 332b in the left-handed circularly polarized states are then depolarized into elliptically polarized states after passing through the over-coating layer 313 that has both the phase tuning and the scattering functions. After the incident lights, 332a and 332b are randomly reflected from the first metallic reflective layer 315 or the bottom surface of the second metallic reflective layer 311, the incident lights, 332a and 332b become depolarized or elliptically polarized light.

The depolarized or elliptically polarized light can be divided into left-handed circularly polarized component light and right-handed circularly polarized component light. Therefore, when the depolarized or elliptically polarized incident light 332a, 332b are reflected back to the bottom circular polarizer 316, the left-handed circularly polarized component light of the incident light 332a and the incident light 332b may be blocked from entering the bottom circular polarizer 316 and scattered back into the over-coating layer 313 to be recycled again, while the right-handed circularly polarization component light of the incident light 332a and the incident light 332b passes through the bottom circular polarizer 316.

Reflected by reflective polarizer 334, the passed-through component light with the right-handed circularly polarization state from the incident light 332a and the incident light 332b is recycled and redirected into the transmissive part 301 from the region either (1) covered by the first metallic reflective layer 315 or (2) uncovered by the first metallic reflective layer 315 but covered by the second metallic reflective layer 311.

In this way, the BLU light portion in the reflective part 302 is recycled into the transmissive part 301 and backlight recirculation is realized. Through the backlight recirculation, more light is redirected into the transmissive part 301 from the reflective part 302, which would be impossible for conventional transflective LCDs to achieve due to the handedness conflict inherent in their circular polarizer configuration. Therefore, higher optical output efficiency from BLU is obtained and enhanced brightness in the transmissive part 301 is achieved. Since more backlight is more efficiently used, the power consumption from BLU is reduced, resulting in a transflective LCD having efficient power saving ability.

2.4 Circular Polarization with a Light Redirecting Film

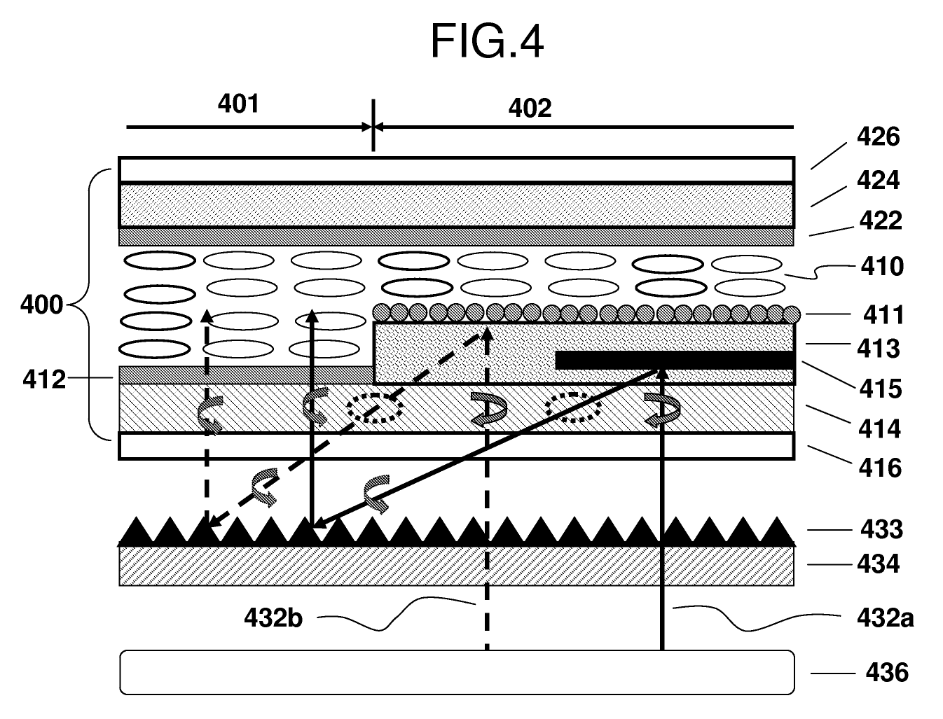

FIG. 4 illustrates a schematic cross-sectional view of an example transflective LCD unit structure 400. This LCD unit structure 400, which may comprise a pair of circular polarizers to transmit circularly polarized light, comprises a configuration for recycling circularly polarized light. A circular polarizer may comprise a linear polarizer with a quarter-wave plate, or comprise a linear polarizer with a half-wave plate and a quarter-wave plate to form a wide-band circular polarizer.

In some embodiments, the LCD unit structure 400 comprises at least a transmissive part 401 and a reflective part 402. A liquid crystal layer 410 is located between a bottom substrate 414 and a top substrate 424. The transmissive part 401 may have a different liquid crystal cell gap than the liquid crystal cell gap of the reflective part 402.

An over-coating layer 413 may be located in the reflective part 402 to make the liquid crystal cell gap of the reflective part smaller than the liquid crystal cell gap of the transmissive part 401. In some embodiments, in part due to the over-coating layer 413, the liquid crystal cell gap in the reflective part 402 may be approximately half of that in the transmissive part 401. The material of the over-coating layer 413 may comprise acrylic resin, polyamide, or novolac epoxy resin. The over-coating layer 413 may be doped with inorganic particles such as silicon oxide (SiO2) to provide scattering and diffusive optical properties. In some embodiments, the over-coating layer 413 may comprise an anisotropic liquid crystal material doped with suitable dopants in order to perform a phase tuning function. In some other embodiments, the over-coating layer 413 may comprise a polymer liquid crystal material.

A first metallic reflective layer 415 may be located on the inner surface of the bottom substrate 414 in the reflective part 402, which is the top surface of the bottom substrate 414 in FIG. 4. The first metallic reflective layer 415 can be prepared during a TFT process either as an extended gate metal or a separate reflective metal layer. The first metallic reflective layer 415 can comprise an opaque reflective metal material such as Al or Ag, and occupy a portion, or the whole, of the total area of the reflective area 402. The inner surface, which is the top surface in FIG. 4, of over-coating layer 413 may be covered with a second metallic reflective layer 411 such as aluminum (Al) or silver (Ag) to work as the reflective electrode. In some embodiments, this second metallic reflective layer 411 may be a bumpy metal layer.

The bottom substrate 414 may be made of glass. On the inner surface of the bottom substrate 414 in the transmissive part 401, a transparent indium-tin oxide (ITO) layer 412 may comprise the pixel electrode. Color filters, not shown in FIG. 4, may be located on or near a surface of the top substrate 424. The color filters may cover both the transmissive part 401 and the reflective part 402, or only cover the transmissive part 401. An ITO layer 422 may be located between the top substrate 424 and the liquid crystal layer 410 as a common electrode. A bottom circular polarizer 416 and a top circular polarizer 426 may be attached on outer surfaces of the bottom substrate 414 and top substrate 424 respectively.

A light redirecting film 433 and a reflective polarizer 434 may be located between the BLU 436 and the bottom circular polarizer 416. The light redirecting film 433 can be a tilted prismatic film and function as a light directional tuning film to direct the incident light to a desired substantially vertical up direction in FIG. 4 after the incident light enters or reflects from the light redirecting film 433. The light redirecting prismatic film 433 can cover both the transmissive part 401 and the reflective part 402 as a whole, or alternatively comprise a pattern that covers the reflective part 402 only. To illustrate a clear example, the light redirecting film 433 is depicted in FIG. 4 as having symmetric reflective surface. In some embodiments, the reflective surface of the light redirecting film 433 may be configured with a non-symmetric reflective surface to redirect incident light to the transmissive part 401. For example, the reflective surface on the light redirecting film 433 further away from the transmissive part 401 may be less tilted than that near the transmissive part 401.

The reflective polarizer 434 may comprise a cholesteric liquid crystal film working as a circularly polarized light reflector. The reflective polarizer 434 can reflect the circularly light of one polarizing handedness such as the right-handed one and transmit the circularly light of the other polarizing handedness such as the left-handed one. The reflective polarizer 434 also may comprise multiple layers that enable light recycling. In a particular embodiment, the reflective polarizer 434 may be the CLC film from Merck.

In operation, in the reflective part 402, incident light 432a and incident light 432b from BLU 436 first passes through the reflective polarizer 434 and light redirecting film 433, and then enters the bottom circular polarizer 416 with, for example, a left-handed circularly polarized light state into the bottom region of the reflective part 402. Incident light 432a and incident light 432b, which may be unpolarized at the initial stage from the BLU 436, pass through the bottom circular polarizer 416, and the corresponding light polarization states become the left-handed circularly polarized ones.

The incident light 432a and the incident light 432b in the left-handed circularly polarized states are then depolarized into elliptically polarized states after passing through the over-coating layer 413 that has both the phase tuning and the scattering functions. After the incident lights 432a, 432b are randomly reflected from the first metallic reflective layer 415 or the bottom surface of the second metallic reflective layer 411, the incident lights 432a, 432b become depolarized or elliptically polarized light. This depolarized or elliptically polarized light can comprise left-handed circularly polarized component light and right-handed circularly polarized component light. Therefore, when the depolarized or elliptically polarized incident lights 432a, 432b are reflected back to the bottom circular polarizer 416, the left-handed circularly polarized component light of the incident light 432a and the incident light 432b may be blocked from entering the bottom circular polarizer 416 and scattered back into the over-coating layer 413 to be recycled again, while the right-handed circularly polarization component light of the incident light 432a and the incident light 432b passes through the bottom circular polarizer 416.

Reflected and redirected by reflective polarizer 434 and light redirecting film 433, the passed-through component light with the right-handed circularly polarization state from the incident light 432a and the incident light 432b is recycled and redirected into the transmissive part 401 from the region either (1) covered by the first metallic reflective layer 415 or (2) uncovered by the first metallic reflective layer 415 but covered by the second metallic reflective layer 411.

In this way, the BLU light portion in the reflective part 402 is recycled into the transmissive part 401 and the backlight recirculation is realized. Through backlight recirculation as described herein, more light is redirected into the transmissive part 401 from the reflective part 402, which would be impossible for conventional transflective LCDs to achieve due to the handedness conflict inherent in their circular polarizer configuration. Therefore, higher optical output efficiency from BLU is obtained and enhanced brightness in the transmissive part 401 is achieved. Since more backlight is more efficiently used, the power consumption from BLU is reduced, resulting in a transflective LCD having efficient power saving ability.

3. Extensions and Variations

To illustrate a clear example, transflective LCD unit structures described herein comprise a first metallic reflective layer and a second metallic reflective layer. The transflective LCD unit structures may further comprise a third reflective layer between the first substrate layer and the second substrate layer. This third reflective layer may be placed in the transmissive part or the reflective part of a transflective LCD or both. In some embodiments, the first metallic reflective layer may be of a pattern that comprises multiple reflective components.

To illustrate a clear example, a first electrode layer and a second electrode layer are placed adjacent to a first substrate layer and a second substrate layer, respectively. In other embodiments, both electrode layers may be placed adjacent to one of the first substrate layer and the second substrate layer.

While the preferred embodiments of the invention have been illustrated and described, it will be clear that the invention is not limited to these embodiments only. Numerous modifications, changes, variations, substitutions and equivalents will be apparent to those skilled in the art without departing from the spirit and scope of the invention, as described in the claims.

What is claimed is:

1. A transflective liquid crystal display comprising a plurality of pixels, each pixel comprising:
a first polarizing layer;
a second polarizing layer;
a first substrate layer and a second substrate layer opposite to the first substrate layer, wherein the first substrate layer and the second substrate layer are between the first polarizing layer and the second polarizing layer;
a liquid crystal material between the first substrate layer and the second substrate layer;
an over-coating layer adjacent to the first substrate layer, wherein the over-coating layer comprises at least one opening that forms in part a transmissive part and wherein a remainder of the over-coating layer forms in part a reflective part;
a first reflective layer adjacent to the first substrate layer, wherein the first reflective layer covers at least a portion of the reflective part; and
a second reflective layer between the over-coating layer and the second substrate layer, wherein the second reflective layer substantially covers the reflective part;
wherein the first reflective layer is between the second reflective layer and the first substrate layer.

2. The transflective liquid crystal display according to claim 1, wherein the first polarizing layer and the second polarizing layer are linear polarizers.

3. The transflective liquid crystal display according to claim 1, wherein the first polarizing layer and the second polarizing layer are circular polarizers.

4. The transflective liquid crystal display according to claim 1, wherein the over-coating layer is a scattering and diffusive over-coating layer.

5. The transflective liquid crystal display according to claim 1, wherein the over-coating layer is a phase tuning film.

6. The transflective liquid crystal display according to claim 1, further comprising a light source that directs light through the at least one opening in the over-coating layer; wherein the first polarizing layer is adjacent to an outer surface of the first substrate layer, and wherein the pixel comprises a polarization recycling film between the light source and the first polarizing layer.

7. The transflective liquid crystal display according to claim 6, wherein the pixel comprises a light redirecting film between the light source and the first polarizing layer.

8. The transflective liquid crystal display according to claim 7, wherein the light redirecting film covers both some of the transmissive part and some of the reflective part.

9. The transflective liquid crystal display according to claim 7, wherein the light redirecting film only covers an area of the reflective part.

10. The transflective liquid crystal display according to claim 1, further comprising a first electrode layer adjacent to the first substrate layer.

11. The transflective liquid crystal display according to claim 9, wherein the first electrode layer is an oxide layer.

12. The transflective liquid crystal display according to claim 1, wherein the pixel comprises a switching element that is configured to determine an intensity of light transmitting through the transmissive part.

13. The transflective liquid crystal display according to claim 12, wherein the switching element further comprises a Transistor-Transistor-Logic interface.

14. The transflective liquid crystal display according to claim 1, wherein the transmissive part is covered by a color filter.

15. The transflective liquid crystal display according to claim 1, wherein the pixel further comprises a third reflective layer between the first substrate layer and the second substrate layer, wherein the third reflective layer covers a portion of an area of the pixel.

16. A computer, comprising:
one or more processors;
a transflective liquid crystal display coupled to the one or more processors and comprising a plurality of pixels, a pixel comprising:
a first polarizing layer;
a second polarizing layer;
a first substrate layer and a second substrate layer opposite to the first substrate layer, wherein the first substrate layer and the second substrate layer are between the first polarizing layer and the second polarizing layer;
a liquid crystal material between the first substrate layer and the second substrate layer;
an over-coating layer adjacent to the first substrate layer, wherein the over-coating layer comprises at least one opening that forms in part a transmissive part and wherein a remainder of the over-coating layer forms in part a reflective part;
a first reflective layer adjacent to the first substrate layer, wherein the first reflective layer covers at least a portion of the reflective part; and
a second reflective layer between the over-coating layer and the second substrate layer, wherein the second reflective layer substantially covers the reflective part;
wherein the first reflective layer is between the second reflective layer and the first substrate layer.

17. The computer according to claim 16, wherein the first polarizing layer and the second polarizing layer are linear polarizers.

18. The computer according to claim 16, wherein the first polarizing layer and the second polarizing layer are circular polarizers.

19. The computer according to claim 16, wherein the over-coating layer is a scattering and diffusive over-coating layer.

20. The computer according to claim 16, wherein the over-coating layer is a phase tuning film.

21. The computer according to claim 16, further comprising a light source that directs light through the at least one opening in the over-coating layer; wherein the first polarizing layer is adjacent to an outer surface of the first substrate layer, and wherein the pixel comprises a polarization recycling film between the light source and the first polarizing layer.

22. The computer according to claim 21, wherein the pixel comprises a light redirecting film between the light source and the first polarizing layer.

23. The computer according to claim 16, wherein the pixel comprises a switching element that is configured to determine an intensity of light transmitting through the transmissive part.

24. The computer according to claim 16, wherein the pixel further comprises a third reflective layer between the first substrate layer and the second substrate layer, wherein the third reflective layer covers a portion of an area of the pixel.

25. A method of fabricating a transflective liquid crystal display, comprising:
providing a plurality of pixels, a pixel comprising:
a first polarizing layer;
a second polarizing layer;
a first substrate layer and a second substrate layer opposite to the first substrate layer, wherein the first substrate layer and the second substrate layer are between the first polarizing layer and the second polarizing layer;
a liquid crystal material between the first substrate layer and the second substrate layer;
an over-coating layer adjacent to the first substrate layer, wherein the over-coating layer comprises at least one opening that forms in part a transmissive part and wherein a remainder of the over-coating layer forms in part a reflective part;
a first reflective layer adjacent to the first substrate layer, wherein the first reflective layer covers at least a portion of the reflective part; and
a second reflective layer between the over-coating layer and the second substrate layer, wherein the second reflective layer substantially covers the reflective part;
wherein the first reflective layer is between the second reflective layer and the first substrate layer.

26. The method according to claim 25, wherein the first polarizing layer and the second polarizing layer are linear polarizers.

27. The method according to claim 25, wherein the first polarizing layer and the second polarizing layer are circular polarizers.

28. The method according to claim 25, wherein the over-coating layer is a scattering and diffusive type.

29. The method according to claim 25, wherein the over-coating layer is a film with a phase tuning function.

30. The method according to claim 25, further comprising providing a light source that provides light through the at least one opening in the over-coating layer; wherein the first polarizing layer is adjacent to an outer surface of the first substrate layer, and wherein the pixel comprises a polarization recycling film between the light source and the first polarizing layer.

31. The method according to claim 30, wherein the pixel comprises a light redirecting film between the light source and the first polarizing layer.

32. The method according to claim 25, wherein the pixel comprises a switching element that is configured to determine an intensity of light transmitting through the transmissive part.

33. The method according to claim 25, wherein the pixel further comprises a third reflective layer between the first substrate layer and the second substrate layer, wherein the third reflective layer covers a portion of an area of the pixel.
